(19) United States
(12) Patent Application Publication
(10) Pub. No.: US 2009/0013852 A1
(43) Pub. Date: Jan. 15, 2009

(54) Musical Instrument Bell Cap

(75) Inventor: Jeffrey Perry, South Bend, IN (US)

Correspondence Address: FISH & RICHARDSON PC, P.O. BOX 1022, MINNEAPOLIS, MN, 55440-1022, US

(73) Assignee: CONN-SELMER, INC., Elkhart, IN (US)

(21) Appl. No.: 11/775,321

(22) Filed: Jul. 10, 2007

(51) Int. Cl. G10D 9/00

(52) U.S. Cl. 84/453

(57) ABSTRACT

A cap for a musical wind instrument bell includes a flexible substantially circular disk shaped portion sized to span the mouth of the instrument bell and a flexible continuous side wall portion extends from the outer edge of the disk shaped portion. The disk shaped portion and the side wall portion together define a receptacle sized to receive and fit over the instrument bell. The disk shaped portion rests parallel to the mouth of the instrument bell. A fastener system is disposed on the side wall portion and is configured to decrease the opening of the receptacle over the tapering conical region of the instrument bell to releasably secure the cap to the instrument bell.

### TECHNICAL FIELD

This disclosure relates to caps or covers for a bell of a musical instrument.

### BACKGROUND

A wind instrument is a musical instrument that contains some type of resonator (usually a tube), in which a column of air is set into vibration by the player blowing into (or over) a mouthpiece set at the end of the resonator. The pitch of the vibration is determined by the length of the tube and by manual modifications of the effective length of the vibrating column of air. Musical wind instruments generally have a bell from which sound waves emanate during play. The bell of a wind instrument is the round, flared opening opposite the mouthpiece. As used herein, “wind instrument” includes so-called “brass instruments” such as horns, trumpets, etc., so-called “woodwind instruments” such as clarinets, saxophones, etc., and many other kinds of instruments.

### SUMMARY

In one aspect, a cap for a bell of a musical wind instrument includes a flexible, substantially circular disk shaped portion sized to span the mouth of the instrument bell and a flexible continuous side wall portion extending from the outer edge of the disk shaped portion. The disk shaped portion and the side wall portion together define a receptacle sized to receive and fit over the instrument bell. The disk shaped portion rests parallel to the mouth of the instruments bell. A fastener system is disposed on the side wall portion and is configured to decrease the opening of the receptacle over the tapering conical region of the instrument bell to releasably secure the cap to the instrument bell.

Implementations of the disclosure may include one or more of the following features. In some implementations, the fastener system includes an elastic material disposed on the side wall portion and/or the side wall portion is constructed of an elastic material. In some implementations, the fastener system includes a drawstring arrangement for releasably securing the cap around the tapering conical region of the instrument bell. The drawstring arrangement is spaced from the rim of the instrument bell. In other implementations, the fastener system includes a circumferentially extending strap disposed on the side wall portion, a first fastener component disposed on the strap, and at least one second fastener component disposed on the side wall portion and configured to releasably engage the first fastener component. The opening of the receptacle is alterable by engaging the strap along the side wall portion. The fastener components may include hook and loop fastener components or snaps.

In some examples, the disk shaped portion defines a display region for advertisements, decorations, logos, etc. The disk shaped portion may define a pocket configured to receive a microphone (e.g. a wireless microphone). The pocket may be located on an inner or outer side of the disk shaped portion. The disk shaped portion may be comprised of fabric, a polymeric material, and/or an elastic material. Similarly, the side wall portion may be comprised of fabric, a polymeric material, and/or an elastic material. In some examples, the disk shaped portion and the side wall portion are integrally formed of one or more materials.

The details of one or more implementations of the disclosure are set fourth in the accompanying drawings and the description below. Other features, objects, and advantages will be apparent from the description and drawings, and from the claims.

### DESCRIPTION OF DRAWINGS

FIG. 1 is a perspective side view of a bell cap for a musical instrument.

FIG. 2 is a perspective bottom view of a bell cap for a musical instrument.

FIGS. 3-4 are exploded side views of a bell cap and a musical instrument.

FIG. 5 is a side view of a bell cap on a musical instrument.

FIGS. 6-8 are perspective views of a bell cap on a musical instrument.

Like reference symbols in the various drawings indicate like elements.

### DETAILED DESCRIPTION

A bell of a musical instrument is susceptible to bumps, scratches and other damage. The instrument bell, as the source of issuing sound, is typically also a focal point for spectators of the instrument player.

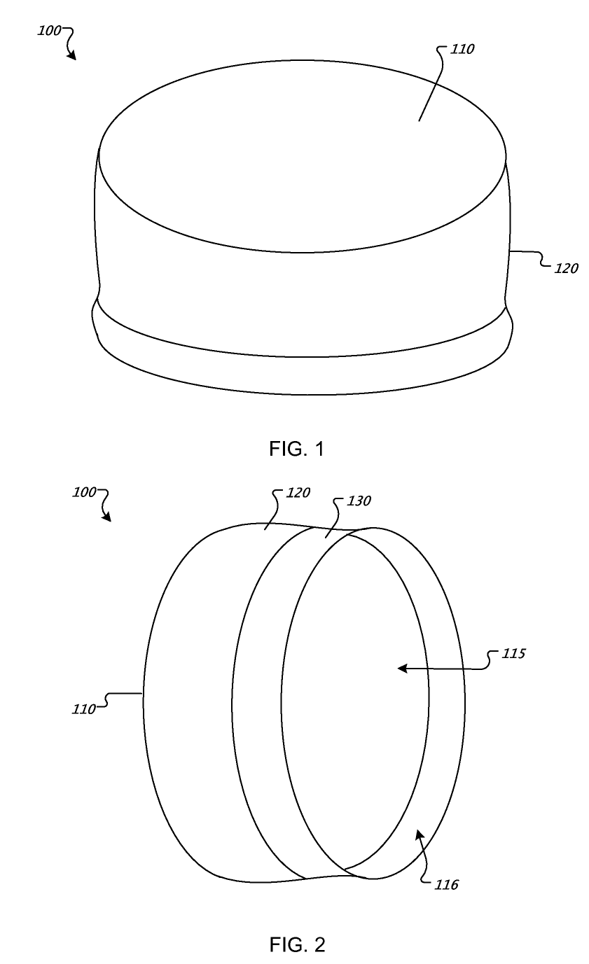

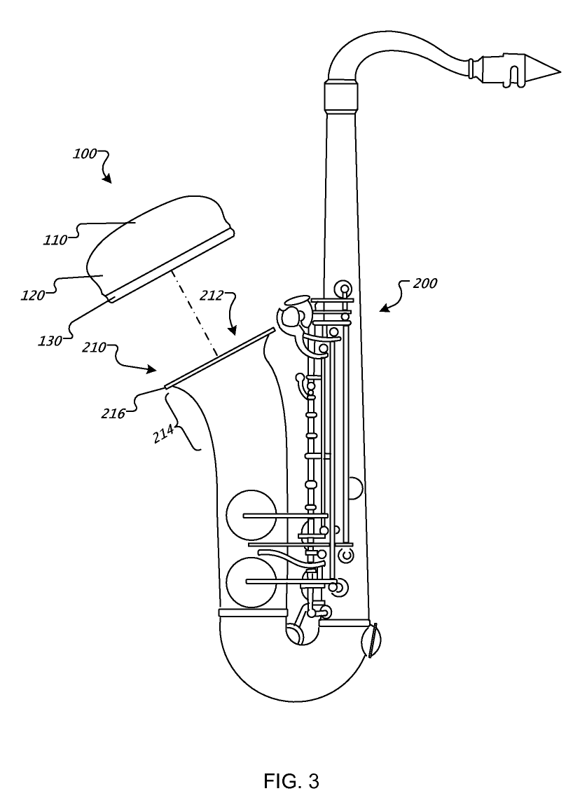

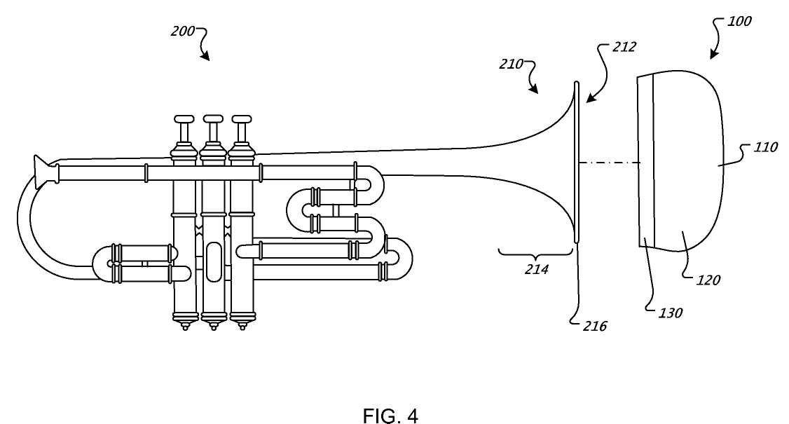

Referring to FIGS. 1-5, a cap 100 for an instrument bell 210 of a musical instrument 200 includes a flexible substantially circular disk shaped portion 110 sized to span the mouth 212 of the instrument bell 210. A flexible continuous side wall portion 120 extends from the outer edge 111 of the disk shaped portion 110. The disk shaped portion 110 and the side wall portion 120 together define a receptacle 115 sized to receive and fit over the instrument bell 210. The disk shaped portion 110 rests parallel to the mouth 212 of the instrument bell 210. A fastener system 130 is disposed on the side wall portion 120 and is configured to decrease the opening 116 of the receptacle 115 over the tapering conical region 214 of the bell 210 to releasably secure the cap 100 to the instrument bell 210. The cap 100 protects the instrument bell 210 from minor damage during play and storage. The cap 100 generally does not materially affect the musical performance of the instrument 200.

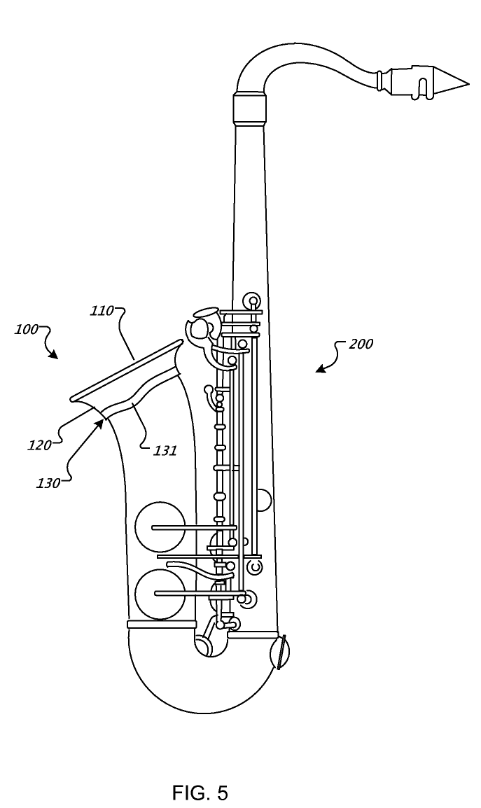

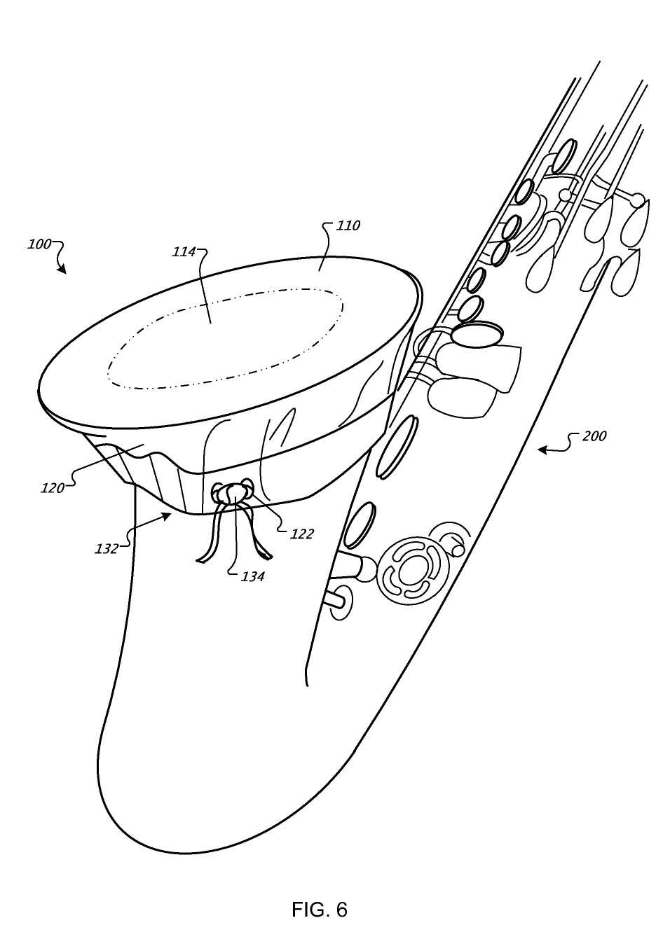

Referring to FIGS. 5-6, in some implementations, the fastener system 130 includes an elastic material 131 disposed on the side wall portion 120. In some examples, the side wall portion 120 comprises an elastic material, such that the side wall portion 120 is elastically deformed for placement over and around the tapering conical region 214 of the instrument bell 210. In another implementation, the fastener system 130 includes a drawstring arrangement 132 for releasably securing the cap 100 around the tapering conical region 214 of the received bell 210. The drawstring arrangement 132 is spaced (e.g. 3-4 cm) from the rim 216 of the received bell 210. In one example, a drawstring 134 is fed through at least two eyelets 122 defined by the side wall portion 120. Tying the drawstring 134 around the received bell 210 secures the cap 100 to the bell 210.

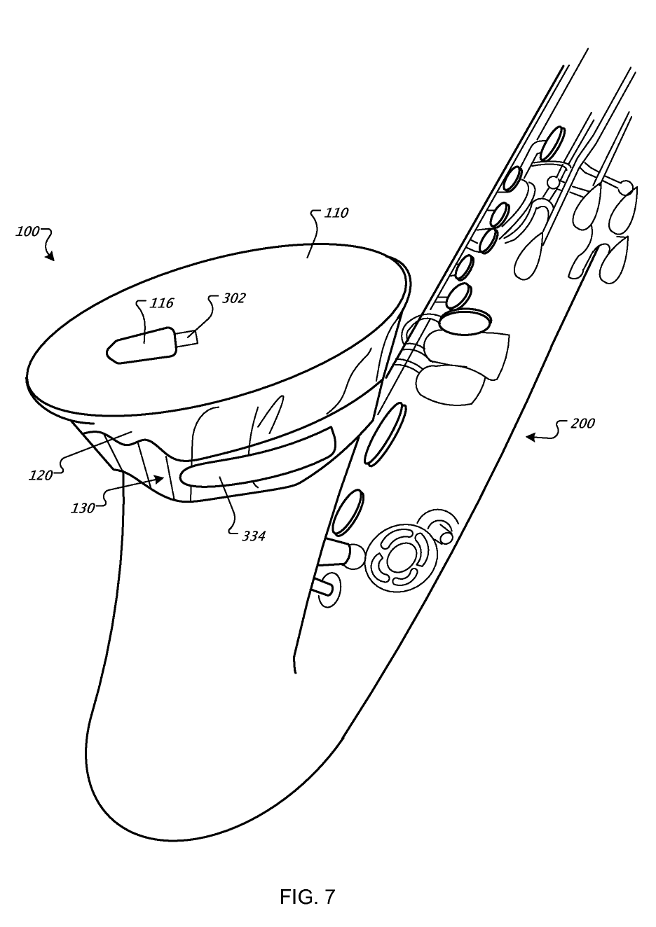

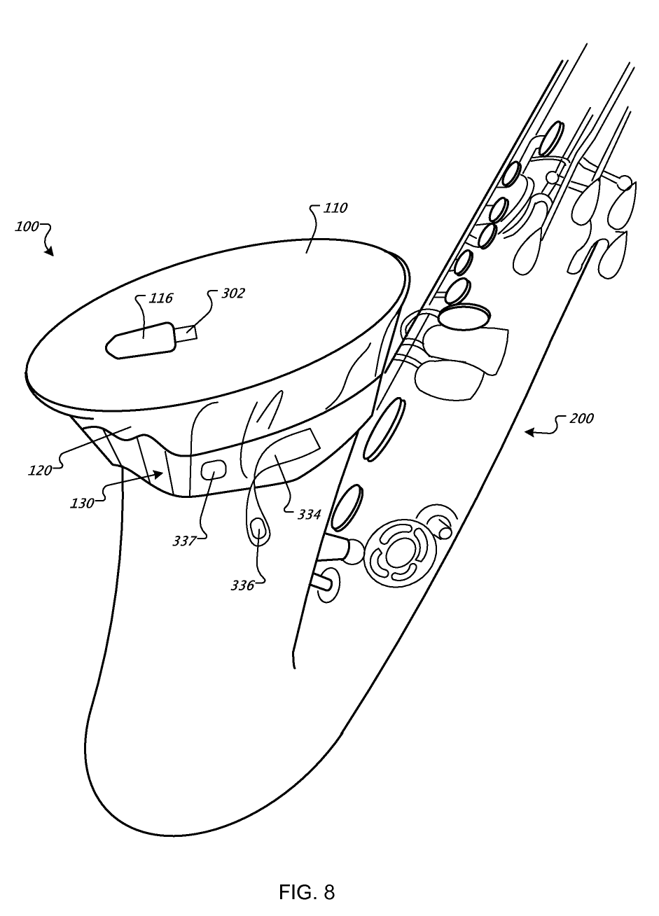

In some implementations, the fastener system 130 includes a circumferentially extending strap 334 disposed on the side wall portion 120, as shown in FIGS. 7-8, a first fastener component 336 (e.g. hook and loop fastener as shown or snap) disposed on the strap, and at least one second fastener component 337 (e.g. hook and loop fastener or snap) disposed on the side wall portion 120 and configured to releasably engage the first fastener component 336. The opening 116 of the receptacle 115 is alterable by engaging the strap 334 along the side wall portion 120. Any suitable fastener component may be employed releasably secure the strap 334 along the side wall portion 120.

Referring again to FIG. 6, the disk shaped portion 110, in some examples, defines a display region 114 for advertisements, logos, or the like. When installed on the bell 210, the disk shaped portion 110 is pulled taut over the instrument bell 210, forming a substantially flat surface that may be used to display decorations, advertisements, etc. In some implementations, the disk shaped portion 110 defines a pocket 116 configured to receive a microphone 302 (e.g. a wireless microphone). The pocket 116 may be positioned in the center of the instrument bell 210 on the inside or outside of the cap 100. The disk shaped portion 110 may comprise fabric, a polymeric material, or an elastic material, allowing the disk shaped portion 110 to be stretched taut over the instrument bell 210. Similarly, the side wall portion 120 may comprise fabric, a polymeric material, or an elastic material, allowing the side wall portion 120 to be stretched over the instrument bell 210 and then constricting down over the tapering conical region 214 of the instrument bell 210. In some examples, the disk shaped portion 110 and the side wall portion 120 are integrally formed of one or more materials. In one example, the entire cap 100 is constructed of an elastic material, which is stretched over the bell 210. The disk shaped portion 110 is stretched over the bell mouth 212 and the side wall portion 120 is stretched around the tapering conical region 214 of the instrument bell 210.

A number of implementations have been described. Nevertheless, it will be understood that various modifications may be made without departing from the spirit and scope of the disclosure. Accordingly, other implementations are within the scope of the following claims.

What is claimed is:

1. A cap for a musical wind instrument bell, comprising:
a flexible substantially circular disk shaped portion sized to span the mouth of the instrument bell;
a flexible continuous side wall portion extending from the outer edge of the disk shaped portion, wherein the disk shaped portion and the side wall portion together define a receptacle sized to receive and fit over the instrument bell, the disk shaped portion resting parallel to the mouth of the instrument bell; and
a fastener system disposed on the side wall portion and configured to decrease the opening of the receptacle over the tapering conical region of the instrument bell to releasably secure the cap to the instrument bell.

2. The cap for a musical wind instrument bell of claim 1, wherein the fastener system comprises an elastic material disposed on the side wall portion.

3. The cap for a musical wind instrument bell of claim 1, wherein the fastener system comprises a drawstring arrangement for releasably securing the cap around the tapering conical region of the received bell, the drawstring arrangement being spaced from the rim of the received bell.

4. The cap for a musical wind instrument bell of claim 1, wherein the fastener system comprises:
a circumferentially extending strap disposed on the side wall portion;
a first fastener component disposed on the strap; and
at least one second fastener component disposed on the side wall portion and configured to releasably engage the first fastener component;
wherein the opening of the receptacle is alterable by engaging the strap along the side wall portion.

5. The cap for a musical wind instrument bell of claim 4, wherein the fastener components comprise hook and loop fastener components.

6. The cap for a musical wind instrument bell of claim 4, wherein the fastener components comprise snaps.

7. The cap for a musical wind instrument bell of claim 1, wherein the disk shaped portion defines a display region.

8. The cap for a musical wind instrument bell of claim 1, wherein the disk shaped portion defines a pocket configured to receive a microphone.

9. The cap for a musical wind instrument bell of claim 1, wherein the disk shaped portion comprises fabric.

10. The cap for a musical wind instrument bell of claim 1, wherein the disk shaped portion comprises a polymeric material.

11. The cap for a musical wind instrument bell of claim 1, wherein the disk shaped portion comprises an elastic material.

12. The cap for a musical wind instrument bell of claim 1, wherein the side wall portion comprises fabric.

13. The cap for a musical wind instrument bell of claim 1, wherein the side wall portion comprises a polymeric material.

14. The cap for a musical wind instrument bell of claim 1, wherein the side wall portion comprises an elastic material.

15. The cap for a musical wind instrument bell of claim 1, wherein the disk shaped portion and the side wall portion are integrally formed.
